(19) United States
(12) Patent Application Publication
(10) Pub. No.: US 2004/0256046 A1
(43) Pub. Date: Dec. 23, 2004

(54) Welding structure of three members

(75) Inventor: Hitoshi Sakakibara, Obu-shi (JP)

Correspondence Address: OLIFF & BERRIDGE, PLC, P.O. BOX 19928, ALEXANDRIA, VA, 22320, US

(73) Assignee: AISAN KOGYO KABUSHIKI KAISHA, Obu-shi (JP)

(21) Appl. No.: 10/866,675

(22) Filed: Jun. 15, 2004

(30) Foreign Application Priority Data
Jun. 17, 2003 (JP) 2003-171617

(51) Int. Cl. B29C 65/02; B29C 43/22; B29C 65/08

(52) U.S. Cl. 156/73.6; 264/69; 156/379.8

(57) ABSTRACT

A welding structure of three members comprises a first synthetic resin member having an opening and a flange formed around the opening, a second synthetic resin member having an opening and a flange formed around the opening, and a third member having an edge portion, the first, second, and third members being to be integrally joined by vibration welding in a state where the edge portion of the third member is held between the flanges of the first and second members so that contact portions of each flange and the edge portion are welded together. In a state prior to the vibration welding, at least one of the first and second members is formed with a circumferential protrusion, the edge portion of the third member is held between the flanges of the first and second members so that the third member is in contact with the first and second members through the protrusion, and the first and second members are assembled with a predetermined clearance between joining portions constructed of parts of the flanges.

### BACKGROUND OF THE INVENTION

1. Field of the Invention

The present invention relates to a welding structure of three synthetic resin members which are joined together by vibration welding.

2. Description of Related Art

One example of conventional products each formed of three members that are joined together by “vibration welding” is disclosed in the form of a container in Japanese patent No. 3,338,154. FIG. 6 is a sectional view of the container. FIG. 7 is an enlarged sectional view of a joining area of three members to be joined together.

A container 100 includes a first member 101 and a second member 102, each having an opening, and a third member 103. The first member 101 has a flange 111 formed around the opening. Similarly, the second member 102 has a flange 112 formed around the opening. Prior to vibration welding, these first and second members 101 and 102 are assembled so that their respective flanges 111 and 112 abut on each other and a edge portion 113 of the third member 103 is held between the flanges 111 and 112. A joining area 120 including the flanges 111 and 112 placed in an abutting state and the edge portion 113 placed therebetween is then joined by vibration welding.

The first, second, and third members 101, 102, and 103 are likely to have errors in wall thickness because they are individually molded by injection. To avoid such a problem, the welding structure in the aforementioned Japanese patent is configured as shown in FIG. 7 to ensure the joining of the first and second members 101 and 102. Specifically, the flange 111 of the first member 101 is formed with a protruding welding face 131, while the flange 112 of the second member 102 is formed with a welding face 132 and a stepped portion 133. This stepped portion 133 is formed to have a greater depth than the thickness of the edge portion 113 of the third member 103. Accordingly, even where the second member 102 and the third member 103 have size errors or deformations resulting from the injection molding, the welding face of the edge portion 113 is located inwardly relative to the welding face 132 of the second member 102. Thus, when the joining area 120 is vibration-welded, the first and second members 101 and 102 are surely welded to each other.

With the above welding structure of three members, it is possible to tightly weld the first and second members 101 and 102 that are assembled in contact with each other before vibration welding. However, the third member 103 and the first member 101 or the second member 102 could not be joined adequately due to insufficient frictional vibration.

Such inadequate joint will be a major matter if the third member 103 is used as a member holding a filter element. To be more specific, when the entire circumference of the third member 103 has not been welded without a break to the first and second members 101 and 102, air may inappropriately pass through gaps generated between the first or second member 101 or 102 and the third member 103 without passing through the filter element held in the third member 103.

### SUMMARY OF THE INVENTION

The present invention has been made in view of the above circumstances and has an object to overcome the above problems and to provide a welding structure of three members whereby a first or second member and a third member can be tightly welded together in their entire circumferential portions.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a welding structure of three members comprising a first synthetic resin member having an opening and a flange formed around the opening, a second synthetic resin member having an opening and a flange formed around the opening, and a third member having an edge portion, the first, second, and third members being to be integrally joined by vibration welding in a state where the edge portion of the third member is held between the flanges of the first and second members so that contact portions of each flange and the edge portion are welded together, wherein, in a state prior to the vibration welding, at least one of the first and second members is formed with a circumferential protrusion, the edge portion of the third member is held between the flanges of the first and second members so that the third member is in contact with the first and second members through the protrusion, and the first and second members are assembled with a predetermined clearance between joining portions constructed of parts of the flanges.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic structural view of a system including a canister;

FIG. 2 is a sectional view of a filter unit;

FIG. 3 is a plane view showing a positional relation between a vibration-welding jig and a fist case;

FIG. 4 is a sectional view of a joining area of three members prior to welding in a preferred embodiment of the invention;

FIG. 5 is a sectional view of the joined area by welding;

FIG. 6 is a sectional view of a container; and

FIG. 7 is an enlarged sectional view of a joining structure of three members forming the container shown in FIG. 6.

### DETAILED DESCRIPTION OF THE PREFERRED EMBODIMENTS

A detailed description of a preferred embodiment of a welding structure of three members embodying the present invention will now be given referring to the accompanying drawings.

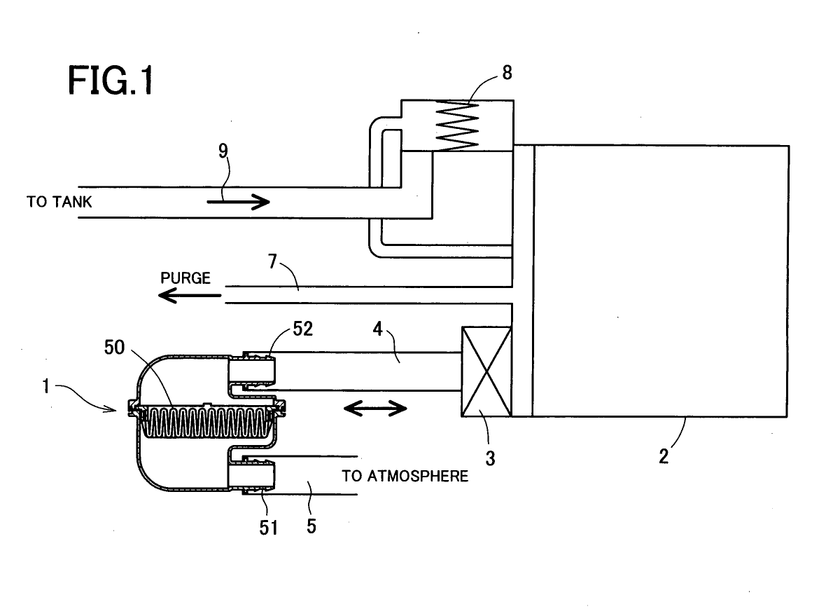

In a system construction shown in FIG. 1, a canister 2 is attached with an air control valve 3 which is connected to an inlet 52 of a filter unit 1. The filter unit 1 houses a filter element 50 at a center in section and has an outlet 51 open to atmosphere.

The canister 2 is connected to a purging passage 7 through which gasoline vapor adsorbed in the canister 2 is supplied to an engine of a vehicle. The canister 2 is also connected to a tank passage 9 through a vapor control valve 8.

The vapor accumulated in the canister 2 is removed by a purging process. The vapor is sucked out of the canister 2 by a negative pressure in an intake manifold and fed into the engine through the purging passage 7. Simultaneously, air is taken into the canister 2 through a passage 4 connected to the inlet 52 and a passage 5 connected to the outlet 51 open to atmosphere. At this time, the filter unit 1 serves to prevent dust existing in the air taken in from entering the canister 2.

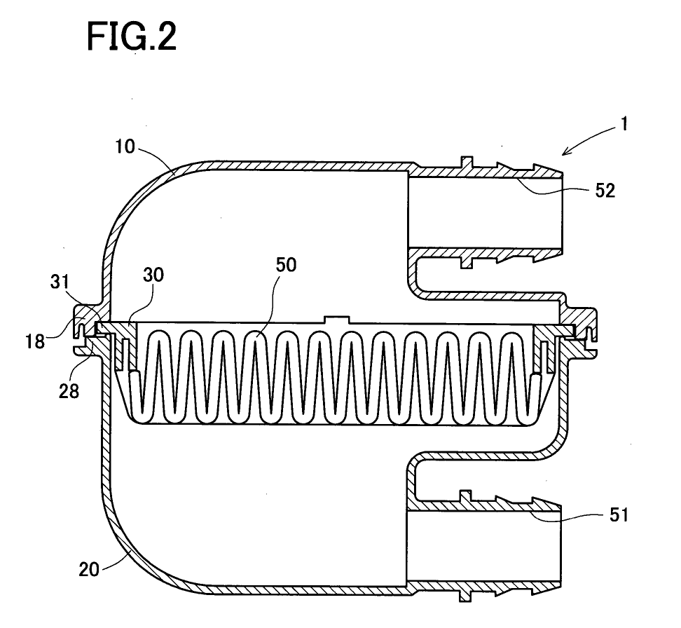

The filter unit 1 includes a first and second cases 10 and 20 made of synthetic resin, which form a housing as shown in FIG. 2 (showing an unwelded state). Each of the first and second cases 10 and 20 is of a halved shape having an opening around which a flange 18 or 28 is formed. Prior to vibration welding, the first and second cases 10 and 20 are assembled so that the flanges 18 and 28 abut on each other and a edge portion 31 of a filter holding member 30 is held therebetween. The filter holding member 30 holds a filter element 50.

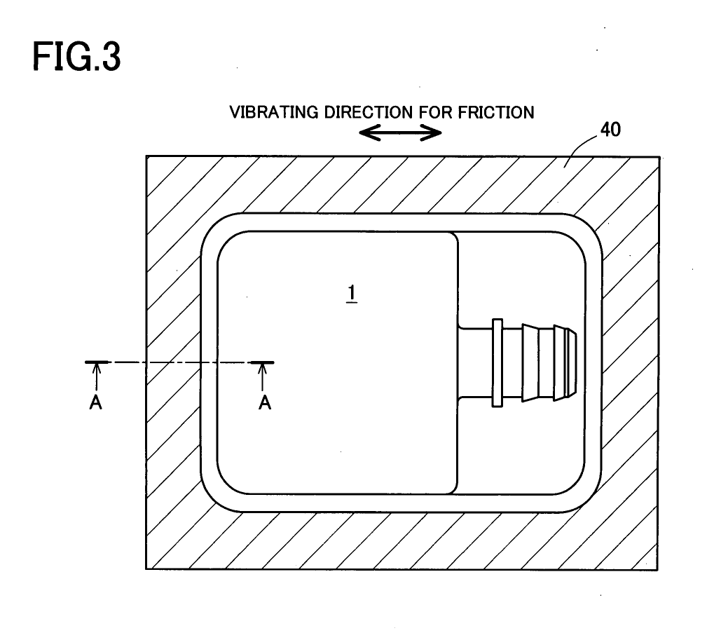

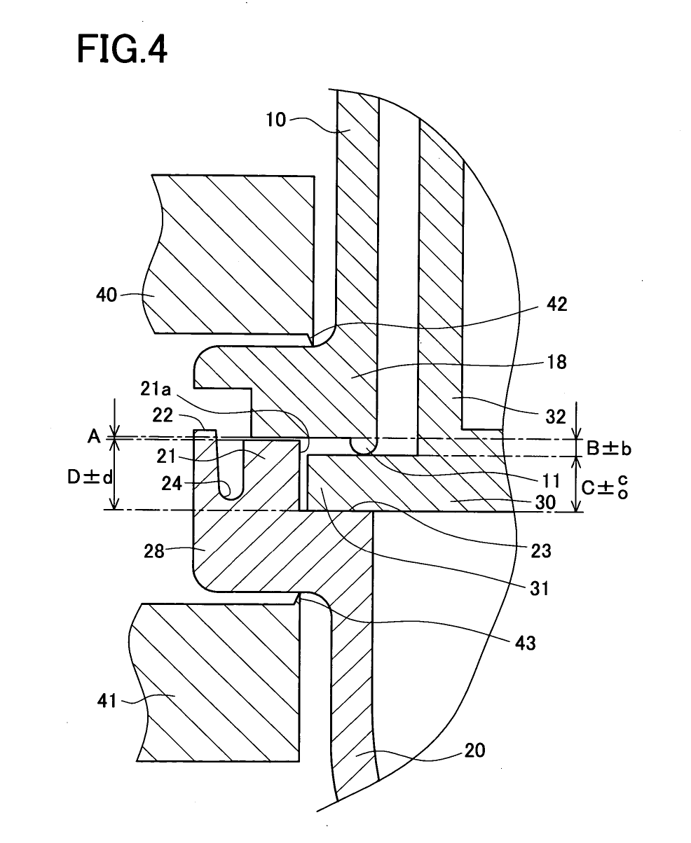

The filter unit 1 is set in a vibration-welding jig 40, as shown in FIG. 3 in top view, with which the first case 10, second case 20, and filter holding member 30 are joined together. This vibration-welding jig 40 is constructed of an upper jig 40a and a lower jig 40b as shown in FIG. 4. Prior to the vibration welding with the use of the jig 40, a joining area of the first case 10, second case 20, and filter holding member 30 is disposed as shown in FIG. 4 which is a sectional view taken along line A-A in FIG. 3.

The filter holding member 30 is placed between the first and second cases 10 and 20 so that the edge portion 31 is held between the flanges 18 and 28. Specifically, the edge portion 30 is sandwiched between a stepped portion 23 of the second case 20 and a circumferential protrusion 11 of the first case 10.

This protrusion 11 of the first case 10 has a semicircular sectional shape and has a height B with a tolerance of ±b and is formed in the flange 18 around the opening. The edge portion 31 of the third case 30 has a thickness C with a tolerance of ±c(−c=0). On the other hand, the second case 20 is formed with a projecting portion 21 having a height D with a tolerance of ±d. The first and second cases 10 and 20 are configured to have a clearance, A, between an upper surface of the projecting portion 21 and a lower surface of the flange 18 when the cases 10 and 20 are put one on top of the other as shown in FIG. 4.

The clearance A is the minimum if the following three conditions are satisfied:

(1) The thickness of the edge portion 31 has a maximum minus tolerance, c, that is, the thickness is “C−c”;

(2) The height of the protrusion 11 has a maximum minus tolerance, b, that is, the height is “B−b”; and

(3) The height of the projecting portion 21 has a maximum plus tolerance, d, that is, the height is “D+d”.

Even where the above conditions are satisfied and the resulting clearance A is the minimum, the clearance A has to be 0.1 mm or more. Accordingly, the above tolerances b, c, and d are determined to provide a clearance A of 0.1 mm or more.

In the present embodiment, the first case 10, second case 20, and filter holding member 30 are designed to have respective tolerances b, c, and d within set values. Thus, the clearance A of 0.1 mm or more is surely produced between the first and second cases 10 and 20.

The second case 20 is further formed with an outside wall 22 surrounding the projecting portion 21 and a circumferential groove 24 defined therebetween.

Next, an explanation is made on a method of vibration-welding the joining area of the first case 10, second case 20, and filter holding member 30 with the use of the vibration-welding jig 40. At first, as shown in FIG. 4, the first case 10, second case 20, and filter holding member 30 are assembled so that the flanges 18 and 28 are put one on top of the other, holding the edge portion 31 therebetween. The first and second cases 10 and 20 are pressed from above and below by a claw-shaped projecting portion 42 of the upper jig 40a and a claw-shaped projecting portion 43 of the lower jig 40b. In this state, an inner peripheral surface 21a of the projecting portion 21 is located outwardly of the projecting portions 42 and 43.

Then, the vibration-welding jig 40 is actuated to vibrate in a direction indicated by a double-headed arrow in FIG. 3, thereby vibrating the first case 10 and second case 20 through the projecting portions 42 and 43 respectively. This causes friction between the protrusion 11 of the first case 10 and the edge portion 31 of the filter holding member 30, generating frictional heat at the interface thereof. The contact surface of the protrusion 11 with the edge portion 31 then starts to melt by the frictional heat. At this time, friction is also caused between the edge portion 31 of the filter holding member 30 and the stepped portion 23 of the second case 20. However, the contact area between the stepped portion 23 and the edge portion 31 is larger as compared with the contact area between the protrusion 11 and the edge portion 31. The frictional heat generated at the contact area of the stepped portion 23 and the edge portion 31 is dissipated and therefore the contact surface of the protrusion 11 will first start to melt.

The clearance A between the first and second cases 10 and 20 is sufficiently smaller than the height B of the protrusion 11. Accordingly, upon start of melting of the contact surface of the protrusion 11, the upper surface of the projecting portion 21 will come into contact with the lower surface of the first case 10. Frictional heat is thus generated between the upper surface of the projecting portion 21 and the lower surface of the first case 10, causing melting thereof.

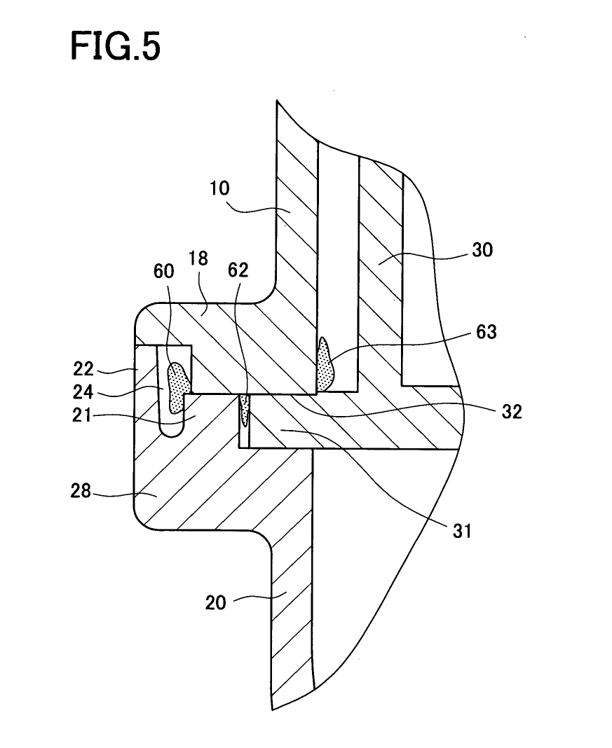

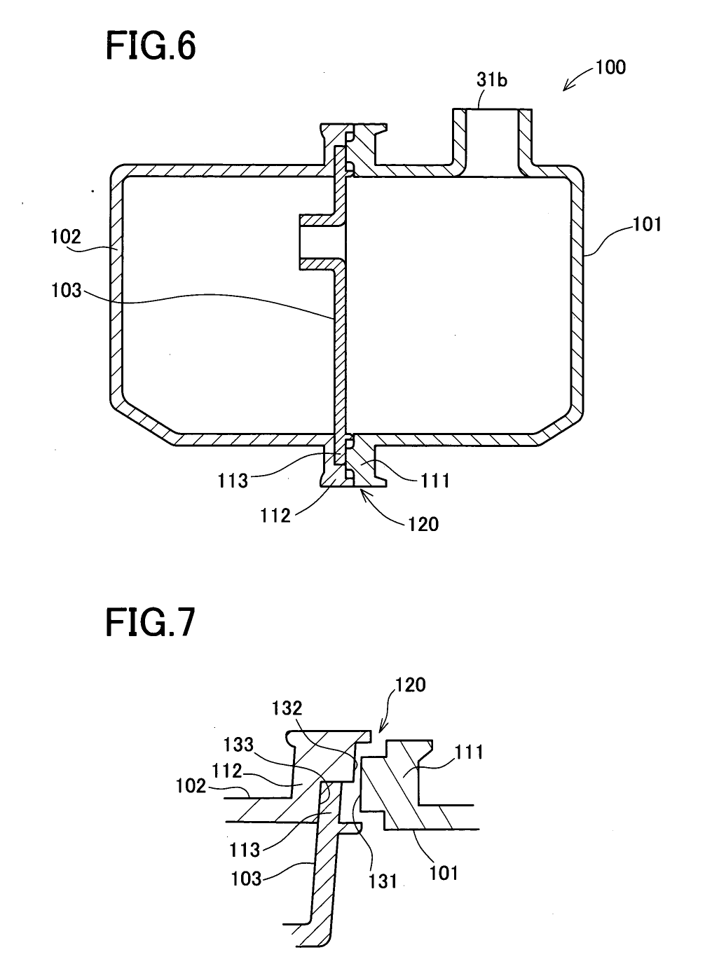

The vibration-welding jig 40 is continuously driven to vibrate until the upper and lower jigs 40a and 40b come to each other at a predetermined distance. In the present embodiment, the jig 40 is operated even after the protrusion 11 is completely melted. During the vibration, burrs 60, 62, and 63 are formed on the joining portions and held in spaces defined by the finally joined portions, as shown in FIG. 5. The outside wall 22 of the second case 20 is brought into contact, at its upper surface, with the first case 10, thereby closing an upper opening of the circumferential groove 24. Enclosed in the closed groove 24, the burr 60 is invisible externally. The outside wall 22 is designed to have a height such that the outside wall 22 is brought into close contact with the first case 10 at the end of vibration welding.

Consequently, in the welding structure of three members in the present embodiment, the protrusion 11 of the first case 10 and the upper surface of the edge portion 31 of the filter holding member 30 are melted first to be joined together. To be more specific, the contact surfaces of the protrusion 11 and the edge portion 31 are smaller in area than other contact surfaces and therefore high frictional heat is faster generated thereat, causing melting of the protrusion 11 and the edge portion 31. Thus, the filter holding member 30 and the first case 10 can tightly be joined together.

By the above welding, a seamless sealing is formed on the entire circumference of the filter holding member 30 with respect to the first case 10. In the case where air is taken in from the atmosphere into the canister 2 through the filter unit 1, the air surely passes through the filter element 50 where dust is caught.

The clearance between the joining portions of the first and second cases 10 and 20, namely, the clearance A between the projecting portion 21 and the flange 18 of the first case 10 is sufficiently smaller than the height B of the protrusion 11. Specifically, the joining portions of the first case 10, second case 20, and filter holding member 30 are designed to provide the clearance A of a predetermined value (0.1 mm) or more between the first and second cases 10 and 20 even when the height of the protrusion 11 is “B−b”, the thickness of the edge portion 31 is “C−c”, and the height of the projecting portion 21 is “D+d”. As the protrusion 11 starts to melt, the joining portions of the first and second cases 10 and 20 come into contact soon and are melted by the frictional heat generated thereat.

As above, the protrusion 11 is tightly joined with the first case 10, thereby surely connecting the fist and second cases 10 and 20. In this way, the flanges 18 and 28 of the first and second cases 10 and 20 are circumferentially joined, forming a air-tight container which has been sealed except for the inlet 52 and the outlet 51.

The vibration-welding is conducted until at least the protrusion 11 is so melted as to disappear, thereby eliminating the clearance (corresponding to the height B of the protrusion 11) defined between the lower surface of the flange 18 and the upper surface of the edge portion 31. At the joining portion of the second case 20, i.e., the projecting portion 21, the first and second cases 10 and 20 are sufficiently melted and tightly joined together.

The projecting portion 21 is provided so that its inner peripheral surface 21a is located outwardly of the projecting portions 42 and 43 through which vibration is transmitted directly from the upper and lower jigs 40a and 40b to the first and second cases 10 and 20 respectively. Accordingly, at an initial stage of vibration-welding, the protrusion 11 is subject to a sufficient load through the projecting portions 42 and 43. This makes it possible to surely melt the protrusion 11 and the edge portion 31, thereby forming a seamless sealing on the entire circumference of the filter holding member 30.

The first and second cases 10 and 20 forming a housing of the filter unit 1 correspond to a first and second members of the invention, and the filter holding member 30 which holds the filter element 50 corresponds to a third member of the invention. According to the welding structure of the three members; the first, second, and third members, in the present embodiment, the housing can be formed without causing leakage. In addition, the filter unit 1 can prevent air from entering the canister 2 without passing through the filter element 50.

The present invention may be embodied in other specific forms without departing from the spirit or essential characteristics thereof. For instance, in the above embodiment, the projecting portion 21 is formed in the second case 20, but may be formed in the first case 10 or formed with a half height in each of the first and second cases 10 and 20.

Although the protrusion 11 in the above embodiment has a semicircular sectional shape, it may has a triangular or other sectional shape.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A welding structure of three members comprising a first synthetic resin member having an opening and a flange formed around the opening, a second synthetic resin member having an opening and a flange formed around the opening, and a third member having an edge portion, the first, second, and third members being to be integrally joined by vibration welding in a state where the edge portion of the third member is held between the flanges of the first and second members so that contact portions of each flange and the edge portion are welded together,
wherein, in a state prior to the vibration welding,
at least one of the first and second members is formed with a circumferential protrusion,
the edge portion of the third member is held between the flanges of the first and second members so that the third member is in contact with
the first and second members through the protrusion, and the first and second members are assembled with a predetermined clearance between joining portions constructed of parts of the flanges.

2. The welding structure of three members according to claim 1, wherein
the protrusion is circumferentially formed in one of the first and second members to have a predetermined height B with a maximum minus tolerance, b,
the edge portion of the third member has a predetermined thickness C with a maximum minus tolerance, c,
one of the first and second members is formed with a projecting portion forming the joining portion having a predetermined height D with a maximum plus tolerance, d, and
the clearance A between the joining portions is a predetermined value or more in the case where the height of the protrusion is “B−b”, the thickness of the edge portion is “C−c”, and the height of the projecting portion is “D+d”.

3. The welding structure of three members according to claim 1, wherein the protrusion has a semicircular sectional shape.

4. The welding structure of three members according to claim 1, wherein the protrusion has a height such that the protrusion is melted to disappear by the vibration welding.

5. The welding structure of three members according to claim 1, wherein the clearance A between the joining portions of the first and second members is set at 0.1 mm or more.

6. The welding structure of three members according to claim 1, wherein one of the first and second members is circumferentially formed with a projecting portion forming the joining portion, an outside wall provided outside the projecting portion, and a groove defined between the projecting portion and the outside wall.

7. The welding structure of three members according to claim 1, wherein one of the first and second members is circumferentially formed with a projecting portion forming the joining portion, and the projecting portion has an inner peripheral surface which is located outwardly of a protruding portion of a vibration-welding jig during the vibration welding.

8. The welding structure of three members according to claim 1, wherein the first and second members put one on top of the other so that their flanges are in contact relation form a housing of a filter, and the third member held in the first and second members is a filter holding member holding a filter element.

9. A welding structure of three members comprising a first synthetic resin member having an opening and a flange formed around the opening, a second synthetic resin member having an opening and a flange formed around the opening, and a third member having an edge portion, the first, second, and third members being to be integrally joined by vibration welding in a state where the edge portion of the third member is held between the flanges of the first and second members so that contact portions of each flange and the edge portion are welded together,
wherein, in a state prior to the vibration welding,
at least one of the first and second members is formed with a circumferential protrusion,
the edge portion of the third member is held between the flanges of the first and second members so that the third member is in contact with the first and second members through the protrusion,
the first and second members are assembled with a predetermined clearance between joining portions constructed of parts of the flanges, and
the protrusion is circumferentially formed in one of the first and second members to have a predetermined height B with a maximum minus tolerance, b,
the edge portion of the third member has a predetermined thickness C with a maximum minus tolerance, c,
one of the first and second members is formed with a projecting portion forming the joining portion having a predetermined height D with a maximum plus tolerance, d,
the clearance A between the joining portions is a predetermined value or more in the case where the height of the protrusion is “B−b”, the thickness of the edge portion is “C−c”, and the height of the projecting portion is “D+d”.

10. The welding structure of three members according to claim 9, wherein the protrusion has a semicircular sectional shape.

11. The welding structure of three members according to claim 9, wherein the protrusion has a height such that the protrusion is melted to disappear by the vibration welding.

12. The welding structure of three members according to claim 9, wherein the clearance A between the joining portions of the first and second members is set at 0.1 mm or more.

13. The welding structure of three members according to claim 9, wherein one of the first and second members is circumferentially formed with a projecting portion forming the joining portion, an outside wall provided outside the projecting portion, and a groove defined between the projecting portion and the outside wall.

14. The welding structure of three members according to claim 9, wherein one of the first and second members is circumferentially formed with a projecting portion forming the joining portion, and the projecting portion has an inner peripheral surface which is located outwardly of a protruding portion of a vibration-welding jig during the vibration welding.

15. The welding structure of three members according to claim 9, wherein the first and second members put one on top of the other so that their flanges are in contact relation form a housing of a filter, and the third member held in the first and second members is a filter holding member holding a filter element.
